(19) United States
(12) Patent Application Publication
(10) Pub. No.: US 2011/0117414 A1
(43) Pub. Date: May 19, 2011

(54) Secondary Battery

(76) Inventors: Kyugil Choi, Yongin-si (KR); Changbum Ahn, Yongin-si (KR)

(21) Appl. No.: 12/944,687

(22) Filed: Nov. 11, 2010

(30) Foreign Application Priority Data
Nov. 18, 2009 (KR) 10-2009-0111453

(51) Int. Cl. H01M 2/18

(52) U.S. Cl. 429/144

(57) ABSTRACT

A secondary battery includes an electrode assembly including a first electrode plate, a second electrode plate, and a separator interposed therebetween, a case in which the electrode assembly and an electrolyte are accommodated, and a core member provided at a center portion of the electrode assembly and impregnating an electrolyte to maintain an external shape of the electrode assembly.

### CROSS-REFERENCE TO RELATED APPLICATION

This application claims the benefit of Korean Patent Application No. 10-2009-0111453, filed Nov. 18, 2009 in the Korean Intellectual Property Office, the disclosure of which is incorporated herein by reference.

### BACKGROUND

1. Field

Aspects of the present invention relate to a secondary battery.

2. Description of the Related Art

More compact and lighter electric and electronic appliances including cellular phones, laptop computers, and camcorders have recently been actively developed and produced. Such portable electric and electronic appliances operate on battery packs when separate power supplies are unavailable. For economic reasons, the battery pack generally comprises a secondary battery, which can be charged and discharged. Exemplary secondary batteries include nickel-cadmium (Ni—Cd) batteries, nickel-hydrogen (Ni—MH) batteries, lithium (Li) batteries, and lithium ion batteries.

Lithium secondary batteries operate at voltages of 3.6 V, which is a voltage three times greater than that of nickel-hydrogen batteries and nickel-cadmium batteries which are widely used as power supplies for portable electronic appliances. Lithium secondary batteries also have a high energy density per unit weight. For these reasons, the lithium secondary batteries are rapidly drawing attention.

Lithium secondary batteries use primarily lithium-based oxides as positive electrode active materials and carbon materials as negative electrode active materials. Lithium secondary batteries are generally classified according to the type of electrolyte used. As such, lithium secondary batteries are classified into lithium ion batteries using liquid electrolytes, and lithium polymer batteries using polymer electrolytes. Lithium secondary batteries can take various shapes, including a cylindrical shape, a prismatic shape, and a pouch shape.

A typical lithium ion secondary battery includes an electrode assembly. The electrode assembly has a positive electrode plate coated with a positive electrode active material, a negative electrode plate coated with a negative electrode active material, and a separator positioned between the positive and negative electrode plates. The separator prevents short circuits and allows only lithium ions to pass. The lithium ion secondary battery also comprises a battery case for containing the electrode assembly and an electrolyte for enabling movement of lithium ions. The electrolyte is injected into the battery case.

The secondary battery can include the electrode assembly formed by stacking or winding the positive electrode plate, the negative electrode plate and the separator interposed therebetween. In a case where the electrode assembly is a wound electrode assembly, the electrode assembly may have a large curvature at its lateral sides, resulting in twisting. In a case where the electrode assembly is a stacked electrode assembly, gaps between each of the positive electrode, the negative electrode, and the separator may be produced due to the generation of gas inside the battery, resulting in deformation of the electrode assembly with the passage of time. In an electrode assembly having a large area, which is attributable to increasing the battery capacity, the above-stated problems may become more severe.

In association with these drawbacks, a large amount of electrolyte is consumed by the electrode plates and the separator of a secondary battery at an initial assembling stage. Accordingly, the secondary battery having a large-area electrode assembly may be confronted with electrolyte shortage as the battery cycling proceeds over time, thereby resulting in considerable degradation in the battery performance.

### SUMMARY

Aspects of the present invention provide a secondary battery which can prevent an abnormality due to twisting of a wound electrode assembly having a large area or deviation of a stacked electrode assembly.

Aspects of the present invention provide a secondary battery which is suitable for compensating for the shortage of an electrolyte that is violently consumed at an initial assembling stage.

Aspects of the present invention provide a secondary battery including an electrode assembly, which is configured to additionally supplement an electrolyte while preventing deformation of the electrode assembly.

In accordance with one aspect of the present invention, there is provided a secondary battery including an electrode assembly including a first electrode plate, a second electrode plate, and a separator interposed therebetween, a case in which the electrode assembly and an electrolyte are accommodated, and a core member provided at a center portion of the electrode assembly and impregnating an electrolyte to maintain an external shape of the electrode assembly.

According to an aspect of the invention, the electrode assembly may be of a stack type in which the first electrode plate, the separator and the second electrode plate are stacked one on another.

According to an aspect of the invention, the electrode assembly may be of a wound type in which the first electrode plate, the separator and the second electrode plate are wound together.

According to an aspect of the invention, the case may be a pouch-type case, a prismatic case, or a circular case.

According to an aspect of the invention, the core member may have a substantially cuboidal shape.

According to an aspect of the invention, the core member may have a substantially cylindrical shape.

According to an aspect of the invention, the core member may be constructed of a stack including a plurality of fibers.

According to an aspect of the invention, the core member may be formed of non-woven fabric.

According to an aspect of the invention, a volume of the core member may be approximately 10% that of the electrode assembly.

According to an aspect of the invention, the core member may have a plurality of pores formed therein.

According to an aspect of the invention, the electrode assembly may have porosity that is in a range of from about 1% to about 3% by volume of the electrode assembly.

According to an aspect of the invention, the core member may further include a moisture-absorbing agent as an electrolyte-absorbing agent.

According to an aspect of the invention, an electrolyte sealing part may be formed at one side of the core member.

Additional aspects and/or advantages of the invention may be realized by providing a secondary battery including a wound electrode assembly having a large area, which can prevent the electrode assembly from twisting in a lateral direction, thereby preventing a curvature from increasing.

Additional aspects and/or advantages of the invention may also be realized by providing a secondary battery including a wound or stacked electrode assembly, which can prevent deformation of the electrode assembly by reducing gaps between each of the positive electrode, the negative electrode, and the separator, the gaps produced due to internal gas generation.

Additional aspects and/or advantages of the invention may also be realized by providing a secondary battery including a pouch-type case, a prismatic case, or a cylindrical case, which can compensate for the shortage of an electrolyte that is excessively consumed at an initial assembling stage by increasing a total amount of the electrolyte held in the case.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a secondary battery according to one exemplary embodiment of the present invention;

FIG. 2 is a perspective view of a core member provided in the secondary battery illustrated in FIG. 1;

FIG. 3 is a perspective view of a secondary battery according to another exemplary embodiment of the present invention; and

FIG. 4 is a perspective view of a secondary battery according to still another exemplary embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

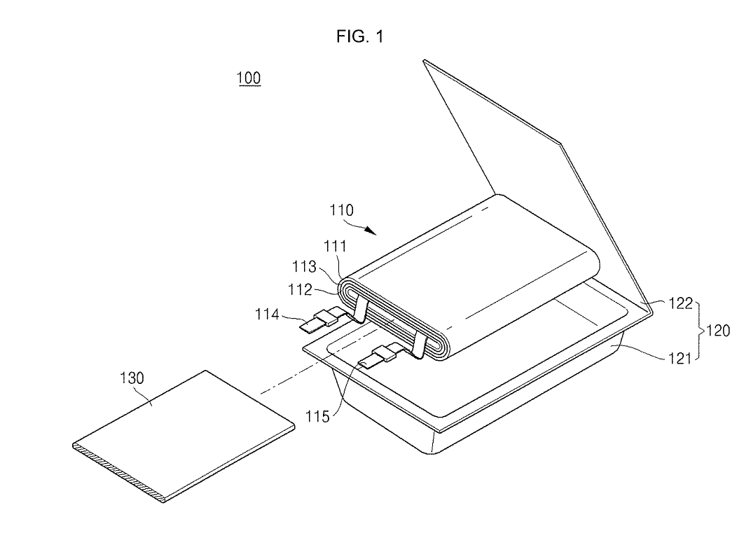

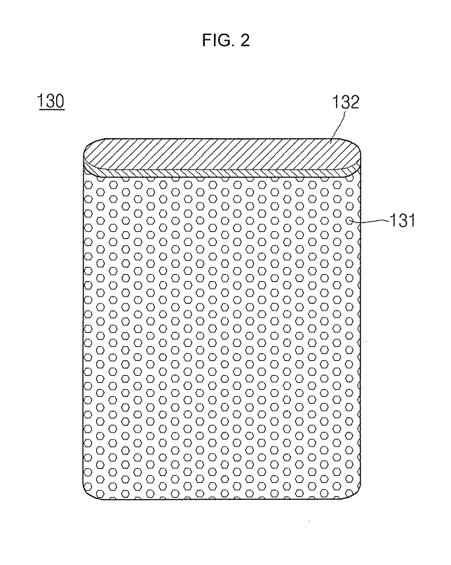

Referring to FIGS. 1 and 2, the secondary battery 100 includes an electrode assembly 110, a pouch-type case 120, and a core member 130. The pouch-type case 120 accommodates the electrode assembly 110. The core member 130 is accommodated in the pouch-type case 120 together with the electrode assembly 110. The core member 130 is provided at a center portion of the electrode assembly 110 and is configured to prevent deformation of the electrode assembly 110 and to hold an electrolyte (not shown). However, the invention is not limited thereto.

The secondary battery 100 is generally adapted for a medium- or large-sized secondary battery. The medium- or large-sized secondary battery may have a large capacity of approximately 5 A or greater, preferably 10 A or greater. However, the invention is not limited thereto and can be used with other capacity batteries.

The electrode assembly 110 includes a positive electrode plate 111, a negative electrode plate 112, and a separator 113 interposed therebetween. The positive electrode plate 111, the negative electrode plate 112, and the separator 113 may be stacked one on another, or wound in a jelly-roll configuration as shown. Although the illustrated embodiment shows the electrode assembly 110 wound in a jelly-roll configuration by way of example, the present invention may also be applied to a stacked electrode assembly. When a stacked electrode assembly is employed as the electrode assembly 110, the same features and effects are demonstrated.

A chalcogenide compound is used as an active material of the positive electrode plate 111. Examples of the compound may include a transition metal oxide, such as LiCoO₂, LiMn₂O₄, LiNiO₂, LiMnO₂, LiNi₁₋ₓCoₓO₂ (where 0≦x≦1), or LiMnO₂.

Examples of an active material of the negative electrode plate 112 may include a carbon material, Si, elemental tin (Sn), a tin oxide, a tin composite alloy, a transition metal oxide, an Li metal nitride, an Li metal oxide, and the like.

In general, the positive electrode plate 111 is made of aluminum (Al). The negative electrode plate 112 is generally made of copper (Cu). The separator 113 is generally made of polyethylene (PE) or polypropylene (PP). However, aspects of the present invention are not limited to those example materials.

In addition, a positive electrode tab 114 is generally made of aluminum (Al) and protrudes away from the positive electrode plate 111 a predetermined length. The positive electrode tab 114 is welded to the positive electrode plate 111. Further, a negative electrode tab 115 is generally made of nickel (Ni) and protrudes away from the negative electrode tab 115 a predetermined length. The negative electrode tab 115 is welded to the negative electrode plate 112. The positive electrode tab 114 is separated from the negative electrode tab 115. However, the materials used to make the positive electrode tab 114 and the negative electrode tab 115 are listed just by way of example, but aspects of the invention are not limited thereto.

The pouch-type case 120 is made of aluminum (Al) and is formed to have a substantially cuboidal shape. The pouch-type case 120 includes a case 121 and cover 122. The case 121 accommodates the electrode assembly 110 and an electrolyte. The cover 122 covers an open top portion of the case 121. In a state in which the positive electrode tab 114 and the negative electrode tab 115 are drawn outside, an edge of the case 121 having the electrode assembly 110 accommodated therein and an edge of the cover 122 are sealed so as to seal the case 120.

In a case where the electrode assembly 110 is a stacked electrode assembly, the core member 130 is positioned at a center portion of a stack of the electrode assembly 110. In a case where the electrode assembly 110 is a wound electrode assembly, the core member 130 is positioned at a center portion of the electrode assembly 110. The core member 130 can therefore be disposed between a separator 113 and a plate 111,112, between plates 111,112, and between pairs of plates 111 or pairs of plates 112.

As shown, the core member 130 is disposed between opposite sides of the negative plates 112, which is at a center of the winding. However, the core member 130 could also be between opposite sides of the positive plates 111 if the winding were to begin with a positive plate 111 facing the center. Further, while described as being at the center portion, it is understood that the core member 130 could be disposed close to the center or at other locations within a stack and/or wound type electrode assembly 110.

The core member 130 may be constructed of a stack including a plurality of fibers. The core member 130 may also be formed of non-woven fabric. The non-woven fabric may be made in a dry type or a wet type.

The shown core member 130 includes a plurality of pores 131 formed in its interior and exterior. The pores 131 are spaces in which the electrolyte is impregnated. A porosity of the core member 130 (that is, a ratio of a total volume of the pores 131 formed in the electrode assembly 110 to a volume of the electrode assembly 110) is preferably in a range of from about 1% to about 3%. Preferably, a volume of the core member 130 is approximately 10% that of the electrode assembly 110. However, the volume ratio of the pores 131 to the core member 130 is not necessarily limited to the above example. In a case of a large-capacity battery, for example, the porosity can further be increased.

The core member 130 may further include a moisture-absorbing agent as an electrolyte-absorbing agent. The moisture-absorbing agent may be an organic material that is resistant to the electrolyte. Therefore, at least one of PPS (polyphenylene sulfide), PI (polyimide) and PET (polyethylene terephthalate) may be used as the moisture-absorbing agent, but aspects of the present invention are not limited thereto.

The core member 130 is formed to have substantially the same size and shape as the electrode assembly 110. As shown, since the electrode assembly 110 has a substantially cuboidal shape, the core member 130 has a substantially cuboidal shape. Therefore, once the core member 130 is inserted into the electrode assembly 110, the electrode assembly 110 is not twisted in a wider-side direction (i.e., in a direction parallel to the top and bottom surfaces of the electrode assembly 110). In addition, since the respective electrode plates 111,112 of the electrode assembly 110 are brought into close contact with each other by inserting the core member 130 into the electrode assembly 110, the deformation of the electrode assembly 110 due to generation of gas inside the battery can be prevented. However, the shape of the core member 130 is not limited to the illustrated example.

In order to prevent leakage of the electrolyte impregnated into the core member 130, a sealing part 132 is formed at a top portion the core member 130. Thus, the core member 130 absorbs and emanates the electrolyte through a region other than the sealing part 132. The sealing part 132 adjoins to portions of the electrode assembly 110 from which the positive and negative electrode tabs 114 and 115 are drawn. Therefore, the sealing part 132 is capable of preventing evaporation of the electrolyte due to heat generated from the positive and negative electrode tabs 114 and 115. While shown being only on one side of the core member 130, it is understood that the sealing part 132 can be on both sides of the core member 130 to prevent leakage on both sides of the electrode assembly 110.

The secondary battery 100 having the aforementioned configuration operates in the following manner. The secondary battery 100 is a secondary battery having the pouch-type case 120, and is advantageously applied to a medium- or large-sized secondary battery. The medium- or large-sized secondary battery may have a large capacity of approximately 5 A or greater, and to the maximum of 10 A or greater.

In a case where the electrode assembly 110 is a stacked electrode assembly, the core member 130 is inserted into a center portion of a stack of the electrode assembly 110. In a case where the electrode assembly 110 is a wound electrode assembly, the core member 130 is inserted into a center portion of a winding core of the electrode assembly 110.

In the secondary battery 100 as illustrated in FIGS. 1 and 2, the electrode assembly 110 absorbs some of the electrolyte accommodated inside the pouch-type case 120 using of the core member 130 inserted into the core member 130. The amount of electrolyte held in the pouch-type case 120 is thus increased as compared to the conventional secondary battery without a core member.

As described above, in the electrode assembly 110 as illustrated in FIGS. 1 and 2, even if a large amount of an electrolyte is consumed at an initial assembling stage of the secondary battery, the electrolyte impregnated into the core member 130 gradually flows out to the electrode plates 111,112 with the passage of time, thereby supplementing the electrolyte which may otherwise become insufficient as the repeated cycling of charge and discharge operations proceeds. In addition, since the core member 130 is inserted into the center portion of the electrode assembly 110, the electrode assembly 110 can be prevented from twisting in a lateral direction of the electrode plates. Further, since the electrode plates 111,112 of the electrode assembly 110 are brought into close contact with each other, deformation of the electrode assembly 110 due to gases generated between the electrode plates 111,112 can be prevented.

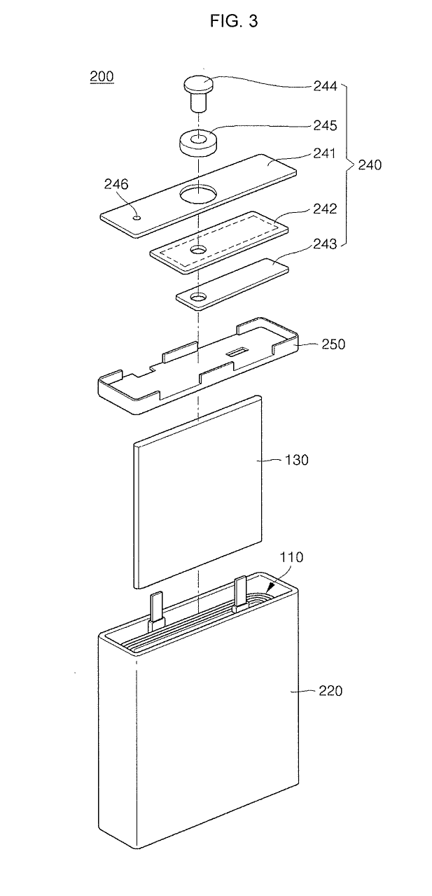

A secondary battery 200 according to another exemplary embodiment of the present invention will be described with reference to FIG. 3, in which like reference numerals refer to the like elements throughout. Referring to FIG. 3, the secondary battery 200 includes an electrode assembly 110, a prismatic case 220 in which the electrode assembly 110 is accommodated, and a core member 130. The core member 130 is inserted into a center portion of the electrode assembly 110 and accommodated in the prismatic case 220.

The secondary battery 200 according to the illustrated embodiment is substantially the same as the secondary battery 100 according to the previous embodiment, except for the use of the prismatic case 220. That is to say, like the secondary battery 100 according to the previous embodiment, the secondary battery 200 is configured such that the electrode assembly 110 and the core member 130 are provided at the center portion of the electrode assembly 110 to prevent deviation of the electrode assembly 110 and an electrolyte is held inside the electrode assembly 110.

Since the electrode assembly 110 according to the illustrated embodiment has the same configuration as that according to the previous embodiment, a detailed description thereof will not be given and only differences are described below.

An upper end opening of the prismatic case 220 is at least hermetically sealed by a cap assembly 240. In a state in which the electrode assembly 110 is inserted into the prismatic case 220, an insulating case 250 is seated on a bottom surface of the cap assembly 240.

The prismatic case 220 is made of a metal, preferably aluminum (Al) or an alloy of Al, which is lightweight and ductile. The prismatic case 220 is preferably formed by deep drawing.

The cap assembly 240 includes a cap plate 241, an insulating plate 242, a terminal plate 243, and an electrode terminal 244. A gasket 245 is inserted between the cap plate 241 and the electrode terminal 244. The electrode terminal 244 and the terminal plate 243 are electrically connected to each other. The insulating plate 242 insulates the cap plate 241 from the terminal plate 243. An electrolyte injection hole 246 is formed at one side of the cap plate 241. A lid (not shown) may be provided at the electrolyte injection hole 246 to at least hermetically seal the electrolyte injection hole 246 after injection of an electrolyte.

The secondary battery 200 having the aforementioned configuration operates in the following manner. The secondary battery 200 includes the prismatic case 220 and is advantageously applied to a medium- or large-sized secondary battery. The medium- or large-sized secondary battery may have a large capacity of approximately 5 A or greater, and to the maximum of 10 A or greater.

In a case where the electrode assembly 110 is a stacked electrode assembly, the core member 130 is inserted into a center portion of a stack of the electrode assembly 110. In a case where the electrode assembly 110 is a wound electrode assembly, the core member 130 is inserted into a center portion of a winding core of the electrode assembly 110.

In the secondary battery 200 illustrated in FIG. 3, the electrode assembly 110 absorbs some of the electrolyte accommodated inside the prismatic case 220 using the core member 130. The amount of electrolyte held in the prismatic case 220 is thus increased as compared to the conventional secondary battery without a core member.

As described above, in the electrode assembly 110 as illustrated in FIG. 3, even if a large amount of an electrolyte is consumed at an initial assembling stage of the secondary battery 200, the electrolyte impregnated into the core member 130 gradually flows out to the electrode plates with the passage of time, thereby supplementing the electrolyte, which may become insufficient as the repeated cycling of charge and discharge operations proceeds. In addition, since the core member 130 is inserted into the center portion of the electrode assembly 110, the electrode assembly 110 can be prevented from twisting in a lateral direction of the electrode plates. Further, since the electrode plates of the electrode assembly 110 are brought into close contact with each other, deformation of the electrode assembly 110 due to gases generated between the electrode plates can be prevented.

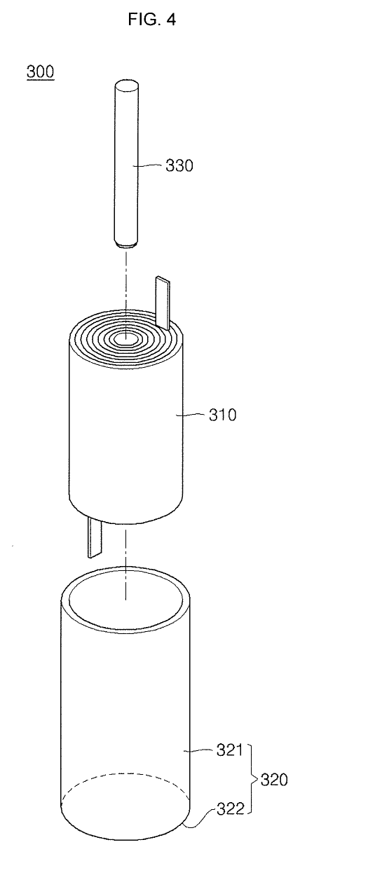

Hereinafter, a secondary battery 300 according to still another exemplary embodiment of the present invention will be described with reference to FIG. 4. The secondary battery 300 includes an electrode assembly 310, a cylindrical case 320 in which the electrode assembly 310 is accommodated, and a core member 330 accommodated in the cylindrical case 320 together with the electrode assembly 310. The core member 330 is provided at a center portion of the electrode assembly 310 and is configured to prevent deformation of the electrode assembly 310 and to hold an electrolyte.

The electrode assembly 310 according to the illustrated embodiment is the same as the electrode assembly 110 shown in FIGS. 1 through 3 in that the electrode assembly 110 includes positive and negative electrode plates and a separator interposed therebetween. Unlike the electrode assembly 110 shown in FIGS. 1 through 3, however, the electrode assembly 310 is configured such that positive and negative electrode plates and a separator are cylindrically wound to have a cylindrical shape.

The cylindrical case 320 has a hollow inner space of a cylindrical shape so as to be combined with the cylindrical electrode assembly 310. The cylindrical case 320 has a cylindrical lateral surface plate 321 having a predetermined diameter, and a bottom surface plate 322 provided at a bottom of the cylindrical lateral surface plate 321 to at least hermetically seal a lower space of the cylindrical lateral surface plate 321. The cylindrical lateral surface plate 321 has an open upper end through which the electrode assembly 310 is inserted. The cylindrical case 320 is generally made of aluminum (Al), iron (Fe), or alloys thereof.

The material of the core member 330 is the same as that of the core member 130 of the one exemplary embodiment illustrated in FIGS. 1 and 2. However, the core member 330 formed in of a cylindrical shape so as to be suitably inserted into a center portion of the cylindrical electrode assembly 310. Therefore, the descriptions about the material of and volume ratio of the pores formed in the core member 130 apply to those of the core member 330.

The secondary battery 300 having the aforementioned configuration operates in the following manner. The secondary battery 300 includes the cylindrical case 320 and is advantageously applied to a medium- or large-sized secondary battery. The medium- or large-sized secondary battery may have a large capacity of approximately 5 A or greater, and to the maximum of 10 A or greater.

The core member 330 is inserted into a center portion of a winding core of the electrode assembly 310. In the secondary battery 300 illustrated in FIG. 4, the electrode assembly 310 absorbs some of the electrolyte accommodated inside the cylindrical case 320 using the core member 330. The amount of electrolyte held in the cylindrical case 320 is thus increased as compared to the conventional secondary battery without a core member.

As described above, in the electrode assembly 310 as illustrated in FIG. 4, even if a large amount of an electrolyte is consumed at an initial assembling stage of the secondary battery 300, the electrolyte impregnated into the core member 330 gradually flows out to the electrode plates with the passage of time, thereby supplementing the electrolyte, which may become insufficient as the repeated cycling of charge and discharge operations proceeds. In addition, since the core member 330 is inserted into the center portion of the electrode assembly 310, the electrode assembly 310 can be prevented from twisting in a lateral direction of the electrode plates. Further, since the electrode plates of the electrode assembly 310 are brought into close contact with each other, deformation of the electrode assembly 310 due to gases generated between the electrode plates can be prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery, comprising:
an electrode assembly including a first electrode plate, a second electrode plate, and a separator interposed therebetween;
a case which accommodates the electrode assembly and an electrolyte; and
a core member within the electrode assembly and which absorbed the electrolyte.

2. The secondary battery of claim 1, wherein the electrode assembly is of a stack type in which the first electrode plate, the separator and the second electrode plate are stacked one on another.

3. The secondary battery of claim 1, wherein the electrode assembly is of a wound type in which the first electrode plate, the separator and the second electrode plate are wound together about the core member.

4. The secondary battery of claim 1, wherein the case is a pouch-type case.

5. The secondary battery of claim 1, wherein the case is a prismatic case.

6. The secondary battery of claim 1, wherein the case is a cylindrical case.

7. The secondary battery of claim 1, wherein the core member has a substantially cuboidal shape.

8. The secondary battery of claim 1, wherein the core member has a substantially cylindrical shape.

9. The secondary battery of claim 1, wherein the core member is constructed of a stack including a plurality of fibers.

10. The secondary battery of claim 1, wherein the core member is formed of a non-woven fabric.

11. The secondary battery of claim 1, wherein a volume of the core member is approximately 10% a volume of the electrode assembly.

12. The secondary battery of claim 1, wherein the core member has a plurality of pores formed therein.

13. The secondary battery of claim 12, wherein a volume of the pores is in a range of from about 1% to about 10% a volume of the electrode assembly.

14. The secondary battery of claim 1, wherein the core member further includes a moisture-absorbing agent as an electrolyte-absorbing agent.

15. The secondary battery of claim 1, wherein an electrolyte sealing part is formed at one side of the core member.

16. The secondary battery of claim 1, wherein the core member is provided at a center portion of the electrode assembly.

17. The secondary battery of claim 1, wherein the core member is disposed between one side of one of the first and second electrode plates.

18. The secondary battery of claim 1, wherein:
the electrode assembly further includes another electrode plate adjacent to the first electrode plate, and
the core member is disposed between the first and another electrode plates.

19. The secondary battery of claim 14, wherein the moisture-absorbing agent is formed of at least one of PPS (polyphenylene sulfide), PI (polyimide) and PET (polyethylene terephthalate).
